(19) United States
(12) Patent Application Publication
(10) Pub. No.: US 2005/0102774 A1
(43) Pub. Date: May 19, 2005

(54) Toothbrush drive shaft and method for production thereof

(76) Inventor: Michael Drossler, Gehrden (DE)

Correspondence Address: FISH & RICHARDSON PC, 225 FRANKLIN ST, BOSTON, MA, 02110, US

(21) Appl. No.: 10/499,055

(22) PCT Filed: Nov. 2, 2002
(86) PCT No.: PCT/EP02/12231

(30) Foreign Application Priority Data
Dec. 17, 2001 (DE) 101 61 977.4

(51) Int. Cl. A61C 17/22

(52) U.S. Cl. 15/22.1

(57) ABSTRACT

The present invention is directed to a toothbrush drive shaft having a shaft shank mounting a force transmission piece, in particular an eccentric crank piece, in a manner preventing relative rotation. Furthermore, the present invention relates to a method of manufacturing such a drive shaft, whereby the force transmission piece and the shaft shank are separately produced and subsequently joined together. According to the invention, the force transmission piece is bent from a wire having a section thereof bent to form a helical wound body and to be pushed onto the shaft shank so it wraps around the shaft shank and sits thereon in a manner preventing relative rotation.

This invention relates to a drive shaft for small electric appliances for personal use. The present invention relates in particular to a toothbrush drive shaft with a shaft shank mounting a force transmission piece, in particular an eccentric crank piece, in a manner preventing relative rotation. Furthermore, the present invention relates to a method of manufacturing such a drive shaft, whereby the force transmission piece and the shaft shank are separately produced and subsequently joined together.

In electric toothbrushes the brush head is as a rule connected with the electric motor of the toothbrush by means of a transmission that converts the rotary drive motion of the electric motor into an oscillatory rotary drive motion, causing the brush head to be driven in a reciprocating motion. Typically, provision is made for a secondary shaft coupled to the brush head and including an eccentric crank piece through which it is driven from the motor by a further part of the drive train or transmission.

A drive shaft of this type is disclosed, for example, in EP 0 560 758 B1, whereby the shaft end close to the motor mounts a crank plate carrying an eccentric coupling pin arranged parallel to the longitudinal axis of the shaft. This known drive shaft is, however, capable of improvement in various regards. In view of the tolerances to be held, the force transmission piece constructed as crank plate is difficult, and hence expensive, to manufacture. On the one hand, it is necessary for the coupling pin to be anchored on the crank plate in a precisely defined position. The bore provided for this purpose in the crank plate requires correspondingly high manufacturing accuracy. On the other hand, also the bore with which the crank plate sits on the shaft shank has to be manufactured to very small tolerances in order to obtain the desired press fit and to be able to transmit the necessary torques.

It is, therefore, an object of the present invention to provide an improved drive shaft of the type initially referred to and an improved method for its production, which avoid the disadvantages of the prior art and develop it further in advantageous manner. Preferably, the object is to provide an eccentric force transmission piece for the drive shaft that affords ease and economy of manufacture while yet transmitting moments reliably.

The object identified in the foregoing is accomplished with a drive shaft according to patent claim 1. With regard to the production method, the object identified is accomplished with a method according to patent claim 10. Preferred embodiments of the invention are the subject-matter of the dependent claims.

The present invention hence provides for the force transmission piece to possess a wound body wrapping around the shaft shank in a manner preventing relative rotation. In lieu of a crank plate having a mounting bore for mounting on the shaft shank in a press-fit relationship thereto, provision is made for a helically coiled fastening section sitting on the shaft shank by frictional engagement therewith.

In a further development of the present invention, the force transmission piece including its wound body and a function arm connected therewith may be integrally made of one piece, being in particular formed of bent wire. The force transmission piece may be made of spring steel spring so that it is elastic, forming a spring body.

As function arm provision may be made in particular for a freely projecting crank arm by means of which a moment is transmissible from and to the shaft. Preferably, the crank arm is an eccentric coupling pin extending roughly parallel to the shaft longitudinal axis and suitable for engagement by the next component in the gear train. In this arrangement the coupling pin is preferably formed by a protruding end of the wire from which the wound body of the spring element is wound.

Advantageously, the spring body, meaning the wound body, may be manufactured at very low cost on a conventional spring coiling machine for compression and tension springs. With respect to process engineering, the invention hence provides for the force transmission piece to be bent from a length of wire a section of which is bent to form the helical wound body and is then pushed onto the shaft shank so that the wound body sits on the shaft shank in non-rotatable relationship thereto. In this process it is not necessarily the wound body that has to be moved in order to be fitted onto the shaft shank. It is also possible for the shaft to be pushed into the stationary and fixedly held wound body.

It will be appreciated that winding the wound body directly onto the shaft shank may also be contemplated. However, it is of particular advantage to first manufacture the wound body, without the shaft being involved, to an inside diameter smaller than the outside diameter of the shaft shank and then, using an expansion tool, to expand the wound body elastically to a mounting diameter which is at least as large as the outside diameter of the shaft shank and slide it onto the shaft shank. As soon as the wound body occupies the desired position on the shaft shank, the elastic expansion is canceled by withdrawal of the expansion tool, causing the wound body to return or attempt to return to its initial diameter, whereby it wraps tightly around the shaft shank. As a result, it is permanently held on the shaft shank by frictional engagement therewith.

In order to achieve the desired rotational alignment of the force transmission piece relative to the shaft, use can be made of alignment elements on the expansion tool, by means of which the function arm of the force transmission piece on the one hand and, on the other hand, the section of the shaft shank defining the rotational orientation are sensed or gripped. Conventionally, the end of the shaft shank remote from the force transmission piece may possess a flattening or a notch so it is not completely symmetrical about its axis and it is necessary to provide for the rotational alignment of the force transmission piece during assembly.

As an alternative or addition to the frictional seating engagement of the wound body with the shaft shank, provision could also be made for positive engagement between the wound body and the shaft shank. For example, an oval cross-section of the shaft shank in the region of the force transmission piece and a corresponding oval contour of the wound body could be provided. Preferably, however, the wound body sits on the circular shaft shank solely by frictional engagement therewith. In the event of an overload condition occurring, this enables slipping of the force transmission piece to be accomplished in advantageous manner, without damaging the connection between the force transmission piece and the shaft shank. In contrast thereto, overloading invariably results in permanent damage in cases where conventional crank plates are used. In the case of a conventional crank plate the sliding moment is substantially lower than the loosening moment, rendering the assembly useless in the event of the connection being overloaded. By contrast, on overloading and corresponding slipping of a force transmission piece with the wound body of the invention, the corresponding assembly remains fit for use. It is only necessary to perform once again a rotational alignment between the wound body, meaning the force transmission piece, and the shaft shank. The loosening and the sliding moments of the wound body sitting on the shaft shank by frictional engagement therewith are largely identical.

Both the wound body and the shaft shank are suitably shaped in a circular cylindrical configuration. The shaft shank is circular cylindrical at least in that section thereof which mounts the wound body.

The wrap angle of the wound body can be selected differently in dependence upon the torque to be transmitted. In accordance with Eytelwein's principle, the transmissible torque can be increased with the wrap angle increasing. In an advantageous aspect of the invention, the wrap angle is between 4 π and 12 π, preferably 6 π to 10 π. In view of the typical torques to be transmitted by the drive mechanism of electric toothbrushes, the wrap angle may amount to about 8 π, that is, the helical wound body wraps around the shaft about four times.

The material thickness of the wire from which the force transmission piece is wound may be selected differently, in particular it may be adapted to the diameter of the shaft shank. Depending on the application, the wire diameter may be selected in accordance with the diameter of the coupling pin carried by the coupling plate to be replaced. This makes it possible to use the drive shaft as replacement part without the need to modify the remaining parts of the transmission between electric motor and toothbrush head.

In a further development of the invention, the wire used for the wound body has a material diameter smaller than the diameter of the shaft shank, amounting preferably to about ¼ to ½ of the shaft shank diameter.

The present invention will be described in more detail in the following with reference to a preferred embodiment and the accompanying drawings. In the drawings,

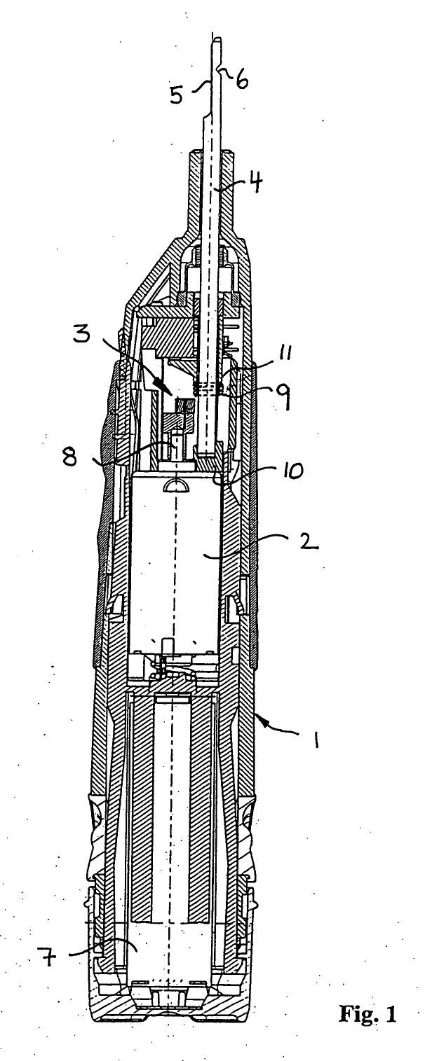

FIG. 1 is a sectional view of an electric toothbrush with a motor-driven secondary shaft according to a preferred embodiment of the invention, whereby the secondary shaft mounts a crank piece functioning as force transmission piece and having a wound section made of spring steel;

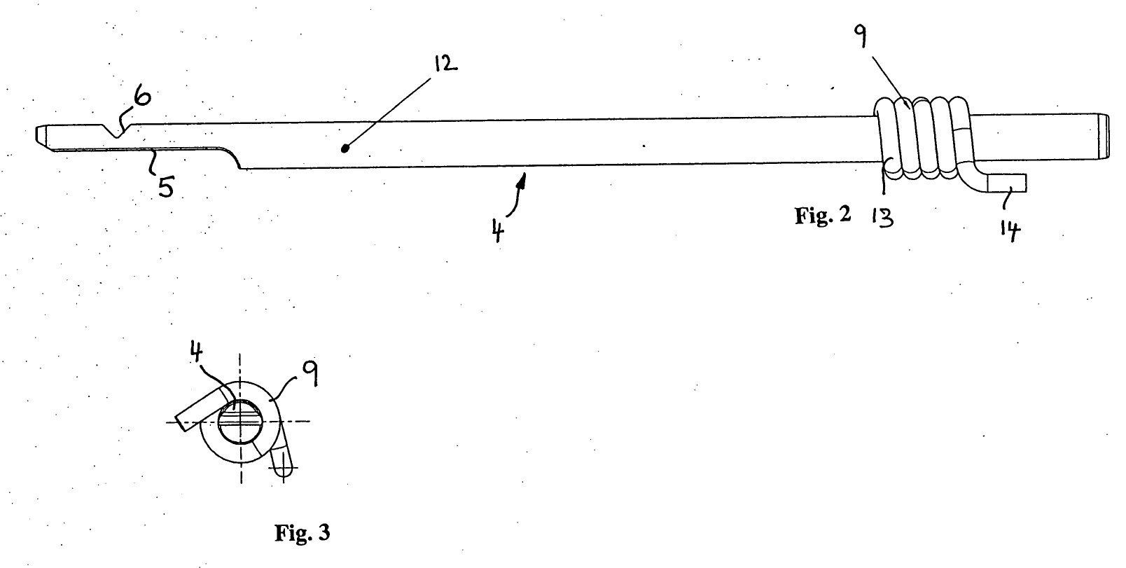

FIG. 2 is an enlarged side view of the secondary shaft mounting the crank piece of the toothbrush of FIG. 1;

FIG. 3 is a top plan view of the end of the secondary shaft of FIG. 2 showing the rotational alignment of the crank piece relative to the flattened end of the secondary shaft;

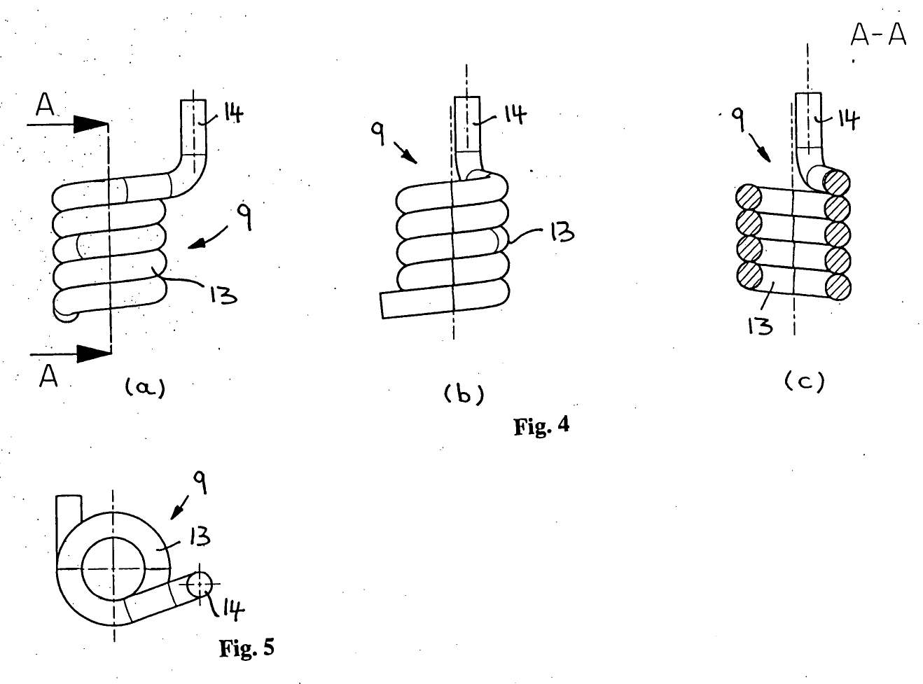

FIG. 4 is an enlarged top plan view of the crank piece constructed as spring body with wound section from the preceding Figures, with the partial view (b) being rotated through 90° relative to the partial view (a), and the partial view (c) being a section through the spring body taken along the line A-A of the partial view (a); and

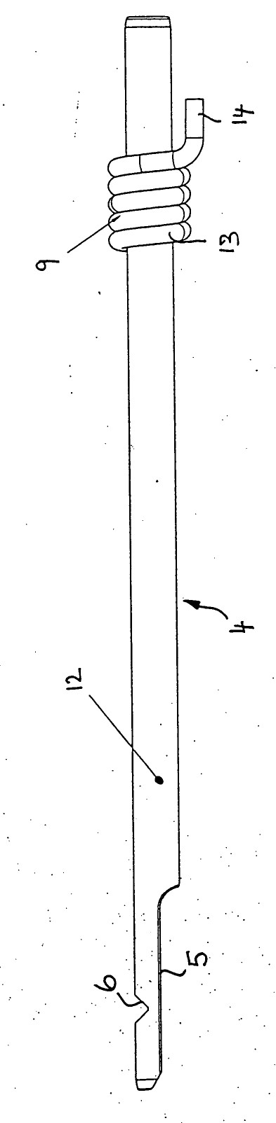

FIG. 5 is a top plan view of the end of the spring body of FIG. 4.

The electric toothbrush illustrated in FIG. 1 possesses in a manner known per se a casing 1, which constitutes the handpiece of the toothbrush and accommodates an electric driving mechanism for imparting movement to a brush attachment not shown. Received in the casing 1 are an electric motor 2 and a transmission 3 driven thereby and comprising a secondary shaft 4 extending from the end of the casing 1 in order to drive a brush head attachable to the end of the casing 1 in an oscillatory rotary movement. For this purpose, the secondary shaft 4 has at its forward end a flattening 5 and a notch provided opposite said flattening to enable coupling engagement with the drive train received in the brush head. Provided at the opposite rear end of the casing 1 is a battery holder 7 receiving batteries for the supply of power to the electric motor 2.

As shown in FIG. 1, the secondary shaft 4 and the electric motor 2 with its motor output shaft 8 are arranged parallel, yet offset to one another. Between the motor output shaft 8 and the secondary shaft 4 the transmission 3 comprises various engagement and offsetting parts such as crank, coupling and rocker, as well as finally the crank piece 9 sitting on the secondary shaft 4 in a manner prevent relative rotation, as will be explained, in order to translate the rotary motion of the motor output shaft 8 into an oscillatory rotational motion of the secondary shaft 4 in a manner known in the art.

The secondary shaft 4 is rotatably mounted in the casing 1, yet fixedly carried therein axially. With its rear end it sits in a bearing bushing 10 that absorbs axial thrust. The secondary shaft 4 may be secured against being pulled out by the crank piece 9 sitting fixedly on the shaft shank, through which crank piece the shaft abuts or would abut axially a shoulder 11 formed fast with the casing if pulling forces act on the shaft.

As FIG. 2 shows, the secondary shaft 4 comprises a straight, elongate shaft shank 12 shaped in a cylindrical configuration of circular cross-section with the exception of its end providing the flattening 5 and the notch 6. The shaft shank may be suitably made of steel or a similarly high-strength material.

As FIGS. 2 and 3 show, the crank piece 9 comprises a helical wound body 13 and a function arm 14 fixedly connected with the wound body 13 and shaped in the manner of a crank pin projecting from the shaft shank 12 eccentrically. As FIG. 2 shows, the crank arm or crank pin extends essentially parallel to the longitudinal axis of the shaft shank 12.

The wound body 13 and the crank arm 14 are integrally made of one piece, forming a spring body made of spring steel. The wound body 13 is helically coiled in the manner of a cylinder spring. At one end the spring steel ends in the crank arm 14, which initially extends radially beyond the circumference of the wound body 13 and is finally angled in the longitudinal direction of the wound body, causing the free end of the crank arm 14 to extend parallel to the longitudinal axis of the wound body 13 (see FIGS. 4 (a) and (b)). At the opposite end the spring steel, from which the crank piece 9 is wound, ends likewise slightly radially, as FIG. 5 shows, which facilitates the expansion of the wound body for the purpose of mounting it on the shaft shank, as will be explained later. As FIG. 5 shows, the ends of the wire from which the crank piece 9 is wound extend in different directions, including between them an acute angle as seen in top plan view.

Advantageously, the crank piece 9 with its wound body 13 may be manufactured at very low cost using a conventional spring coiling machine for compression or tension springs. Different numbers of coils of the wound body 13 may be selected and adapted to the torque to be transmitted. In the embodiment shown, provision is made for four complete coils, that is, the wrap angle of the wound body 13 amounts to about 8 π.

The wound body 13 is coiled on the spring coiling machine to an initial inside diameter that is smaller than the outside diameter of the shaft shank 12. By means of an expansion tool not shown in greater detail, the wound body 13 is then slightly expanded, enabling the shaft shank 12 to be inserted into the wound body 13 in axial direction until it occupies the position shown in FIG. 2. As this occurs, care must be taken to ensure that the crank piece 9 assumes the desired rotational alignment relative to the flattening 5. Advantageously, the expansion tool grips the crank arm 14 of the spring body. As the shaft shank 12 is being inserted, the expansion tool at the same time senses or grips its flattening 5 so that the crank arm 14 of the crank piece 9 invariably comes to lie on the shaft shank in the desired alignment relative to the flattening 5.

The elastic expansion of the wound body 13 is then canceled by the expansion tool being released or withdrawn. The wound body 13 will reset itself, contracting radially in its diameter so as to make frictional engagement with the shaft shank 12, sitting thereon in a manner preventing relative rotation.

It will be understood that the crank arm 14 could be angled in different directions. Other than the illustration in the Figures, the freely projecting end forming the crank arm 14 could be bent back, meaning bent downwardly according to FIG. 4, so that it would extend back over the wound body 13 and opposite the wound body and radially outside thereof. In the embodiment illustrated in FIG. 4, the crank arm 14 extends however in a direction away from the wound body 13 so that it projects above the end of the wound body 13 in axial direction. This has the advantage that, while the lever arm is maintained unchanged, more clearance remains in radial direction between the shaft shank and the crank arm 14 because the wound body 13 does not extend therebetween. This enables the rocker of the transmission 3 to have more substance in the area around the recess engaged by the crank arm 14.

Spring steel of different diameters may be used for the crank piece 9, and the material thickness may be adapted to the moments to be transmitted or also to the diameter of the shaft shank. Given the typical diameters of toothbrush secondary shafts, the material thickness of the spring steel from which the wound body 13 is coiled amounts to between 1 and 2 mm, preferably between 1 and 1.5 mm. In the embodiment illustrated, provision is made for a spring wire with a circular diameter of 1.2 mm, approximately.

The secondary shaft shown in FIG. 2 is inserted into the casing 1 of the electric toothbrush together with the crank piece 9 mounted thereon non-rotatatively so that the secondary shaft is held in the bearings provided for this purpose. The crank piece 9 with its crank arm 14 is fitted into the receiving bore or, where applicable, longitudinal groove of the rocker directly succeeding in the drive train, being hence in engagement therewith. The back-and-forth movement of the rocker is then translated by the crank piece 9 into an oscillatory rotary driving movement of the secondary shaft 4.

Apart from the embodiment described in the foregoing, the force transmission piece with the wound body sitting on the shaft in a manner preventing relative rotation may also find use as motor eccentric or as transverse axis on straight shafts. Preferably, however, the force transmission piece previously described constitutes the crank piece 9 of the secondary shaft of an electric toothbrush.

1-12. (canceled)

13. An electric toothbrush comprising:
a casing;
an electric motor enclosed in the casing, the electric motor comprising:
a motor output shaft;
a transmission driven by the motor output shaft, the transmission comprising a crank piece that includes both a helically wound body and a secondary shaft with a shaft shank defining an outer diameter:
the helically wound body disposed about the shaft shank and wound to have a body inner diameter smaller, in a relaxed state, than the outer diameter of the shaft shank, such that the wound body is frictionally engaged against the secondary shaft for resisting relative rotational movement between the wound body and the secondary shaft, and
the secondary shaft extending outward from the wound body through a distal end of the casing; and
a brush head operably connected to a distal end of the secondary shaft.

14. The electric toothbrush of claim 13, wherein the crank piece further comprises a function arm connected with the wound body so that rotational movement of the function arm, about a longitudinal axis of the shaft shank, applies a rotational force to the secondary shaft through the wound body.

15. The electric tooth brush of claim 14 wherein the wound body and function arm are integrally made of one piece.

16. The electric toothbrush of claim 15, wherein the one piece is formed of bent wire.

17. The electric toothbrush of claim 14, wherein the function arm comprises an eccentric coupling pin extending roughly parallel to the longitudinal axis of the shaft shank.

18. The electric toothbrush of claim 17, wherein the coupling pin extends axially from, and extends beyond, the wound body.

19. The electric toothbrush of claim 13, wherein the wound body is made of spring steel.

20. The electric toothbrush of claim 13, wherein the wound body is held on the shaft shank primarily by the frictional engagement due an elastic bias of the wound body.

21. The electric toothbrush of claim 13, wherein the wound body and the shaft shank have mating cross-sectional contours at least where the wound body wraps around the shaft shank.

22. The electric toothbrush of claim 21, wherein the mating cross-sectional contours of the wound body and the shaft shank are of essentially circular cylindrical configuration and resistance to relative rotation between the wound body and the shaft shank is primarily due to frictional engagement between the wound body and the shaft shank provided by an elastic bias of the wound body.

23. The electric toothbrush of claim 21, wherein the mating cross-sectional contours are of substantially non-circular configuration so that positive engagement between the wound body and the shaft shank provides an additional resistance to relative rotation between the wound body and the shaft shank.

24. The electric toothbrush of claim 13, wherein a wrap angle of the wound body around the shaft shank is in the range from about 4 π to about 12 π.

25. The electric toothbrush of claim 24, wherein the wrap angle of the wound body around the shaft shank is in the range from about 6 π and about 10 π.

26. The electric toothbrush of claim 25, wherein the wrap angle of the wound body around the shaft shank is in the range from about 7.5 π and about 8.5 π.

27. The electric toothbrush of claim 13, wherein the wound body has coils with a material diameter smaller than the shaft shank diameter.

28. The electric toothbrush of claim 27, wherein the material diameter of the coils ranges between about one-quarter to about one-half of the shaft shank diameter.

29. A transmission for an electric toothbrush driven by a motor output shaft of an electric motor, the transmission comprising:
a crank piece that includes a helically wound body with a natural shape defining a body inner diameter, and
a secondary shaft that extends outward from the wound body to a brush head drive train;
wherein the body inner diameter is smaller than a shaft outer diameter of the secondary shaft and the wound body is mounted around a shaft shank of the secondary shaft so that an elastic bias of the wound body towards resuming its natural shape brings the wound body and the shaft shank into a frictional engagement that resists relative rotational movement between the wound body and the shaft shank.

30. The transmission of claim 29, wherein the crank piece further comprises a function arm connected with the wound body so that rotational movement of the function arm, about a longitudinal axis of the shaft shank, applies a rotational force to the secondary shaft through the wound body.

31. The transmission of claim 30 wherein the wound body and function arm are integrally made of one piece.

32. The transmission of claim 31, wherein the one piece is formed of bent wire.

33. The transmission of claim 30, wherein the function arm comprises an eccentric coupling pin extending roughly parallel to the longitudinal axis of the shaft shank.

34. The transmission of claim 33, wherein the coupling pin extends axially from the wound body so it protrudes beyond the end of the wound body.

35. The transmission of claim 29, wherein the wound body is made of spring steel.

36. The transmission of claim 29, wherein the wound body is held on the shaft shank primarily by the frictional engagement due the elastic bias of the wound body.

37. The transmission of claim 29, wherein the wound body and the shaft shank have mating cross-sectional contours at least where the wound body wraps around shaft shank.

38. The transmission of claim 37, wherein the mating cross-sectional contours of the wound body and the shaft shank are of essentially circular cylindrical configuration and the resistance to relative rotation between the wound body and the shaft shank is solely due to primarily based on frictional engagement of between the wound body and the shaft shank provided by the elastic bias of the wound body.

39. The transmission of claim 37, wherein the mating cross-sectional contours are of substantially non-circular configuration so that positive engagement between the wound body and the shaft shank provides an additional resistance to relative rotation between the wound body and the shaft shank.

40. The transmission of claim 29, wherein a wrap angle of the wound body around the shaft shank is in the range from about 4 π to about 12 π.

41. The transmission of claim 40, wherein the wrap angle of the wound body around the shaft shank is in the range from about 6 π and about 10 π.

42. The transmission of claim 41, wherein the wrap angle of the wound body around the shaft shank is in the range from about 7.5 π and about 8.5 π.

43. The transmission of claim 29, wherein the wound body has coils with a material diameter smaller than a shaft shank diameter.

44. The transmission of claim 43, wherein the material diameter of the coils ranges between about one-quarter to about one-half of the shaft shank diameter.

45. A drive shaft for small electric appliances, the drive shaft comprising a shaft shank mounting a force transmission piece, wherein the force transmission piece includes a wound body wrapping around the shaft shank in a manner resisting relative rotation between the wound body and the shaft shank.

46. The drive shaft of claim 45 wherein the force transmission piece also includes a function arm connected with the wound body.

47. The drive shaft of claim 46 wherein the wound body and the function arm are integrally made of one piece.

48. The drive shaft of claim 46 wherein the function arm has an eccentric coupling pin extending roughly parallel preferably to the shaft shank longitudinal axis.

49. The drive shaft of claim 48 wherein the coupling pin extends axially from the wound body so it protrudes beyond the latter's end.

50. The drive shaft of claim 47 wherein the one piece is formed of bent wire.

51. The drive shaft of claim 45 wherein the force transmission piece forms a spring body.

52. The drive shaft of claim 49 wherein the force transmission piece is made of spring steel.

53. The drive shaft of claim 45 wherein the wound body is held on the shaft shank under elastic bias solely by frictional engagement therewith.

54. The drive shaft of claim 45 wherein the wound body and the shaft shank have mating cross-sectional contours at least in that shank section in which the wound body wraps around the shaft shank.

55. The drive shaft of claim 54 wherein the mating cross-sectional contours are of circular cylindrical configuration.

56. The drive shaft of claim 45 wherein a wrap angle of the wound body around the shaft shank is in the range from about 4 π to about 12 π.

57. The drive shaft of claim 56 wherein the wrap angle is in the range between about 6 π and about 10 π.

58. The drive shaft of claim 56 wherein the wrap angle is in the range between about 7.5 π and about 8.5 π.

59. The drive shaft of claim 45 wherein the wound body has coils with a material diameter smaller than a shaft shank diameter.

60. The drive shaft of claim 59 wherein the material diameter is in the range between about one-quarter to one-half of the shaft shank diameter.
